(19) United States
(12) Patent Application Publication
(10) Pub. No.: US 2023/0129128 A1
(43) Pub. Date: Apr. 27, 2023

(54) SECURE AND DOCUMENTED KEY ACCESS BY AN APPLICATION

(71) Applicant: Robert Bosch GmbH, Stuttgart (DE)

(72) Inventors: Christoph Burger-Scheidlin, Muenchen (DE); Johannes Ebke, München (DE); Kai Helbig, Leipzig (DE)

(21) Appl. No.: 17/909,474

(22) PCT Filed: Mar. 2, 2021
(86) PCT No.: PCT/DE2021/100208

§ 371 Date: Sep. 6, 2022

(30) Foreign Application Priority Data
Mar. 6, 2020 (DE) 10 2020 202 882.6

(51) Int. Cl. H04L 9/40

(52) U.S. Cl. CPC H04L 63/0442

(57) ABSTRACT

The invention relates to a method for identifying an application (12) that is executed in an apparatus (10) to another communication participant, comprising: obtaining (200) a connection request for a secure connection between the application (12) and the other communication participant (30); forming (202) an information element (60) that comprises at least one item of information about the application (12); signing (204) the information element with a first secret key (52), which is part of a cryptographic asymmetric key pair that is certified by an information certificate (50) issued by an external trusted authority; incorporating the signed information element (60) into a connection request message (70), signing the connection request message with a secret device-specific key that is part of a cryptographic asymmetric key pair that is certified by a device-specific certificate of the apparatus, and transmitting the connection request message to the other communication participant. The invention furthermore relates to a method for authenticating an application with which a secure connection is intended to be set up.

### BACKGROUND OF THE INVENTION

The present invention relates to a method for identifying an application to another communication participant and to a method for authenticating a requesting application in a communication participant, and to a computing unit and to a computer program for performing same.

Encrypted communication is an essential part of modern secure communication. In situations in which previously unknown communication partners meet, encryption is however able to contribute to security only when the identity of the communication partner is able to be guaranteed. If this is not the case, an attacker may insert themselves into the communication chain and thus decrypt and read the communication (man-in-the-middle attacks).

Modern data traffic therefore uses cryptographic certificates in order to identify the communication partner. Such a certificate identifies the owner of a particular cryptographic public key, and thus of the associated key pair. It is possible in principle to validate both partners in a communication using certificates. On the World Wide Web, however, only the server on the Web is generally validated; no certificate is requested from the clients (that is to say from the browser of the user). Certificates are issued by special, particularly trustworthy authorities, the Certification Authorities (CA). Each communication partner trusts certain ones of these trusted authorities and accepts from them any temporally valid certificate that meets certain criteria. Certificates are created in this case on the basis of a request (Certificate Signing Request, CSR) made to the trusted authority or CA. This request comprises data about the person or unit to be authenticated, for example the name. On the basis of these data, the CA performs a corresponding identity check and creates the requested certificate if the check is successful. The certificate contains the public key of the requesting unit, wherein the certificate is usually signed digitally by the trusted authority. The issued certificate may thus indicate that the trusted authority has checked the unit to be authenticated, meaning that all communication partners that trust the trusted authority may consider this check to be successful on the basis of the certificate.

Devices may also be furnished with certificates in this way. In this case, various features suitable for identifying a device may be used, for example a serial number. It is normal for the process to be performed locally by the manufacturer during the manufacture of the devices. To this end, said manufacturer has obtained a manufacturer certificate with special authorization from the Certification Authority and may thus as it were form a local trusted authority (local CA). Such a device certificate and the associated secret key may then be installed on the device, wherein the secret key may also be generated in the device.

However, in the case of devices that are provided with additional components from third parties (for example retrospectively installed program modules or applications), this results in the problem whereby initially all or none of the applications are able to access this device certificate. There is no additional information as to which application on the device uses the device certificate.

Authentication using certificates normally takes place at the beginning, generally directly after the connection has been set up, that is to say in what is known as the handshake. In this handshake, the public parts of the certificates are transmitted and checked. However, only an “external” check on the device thereby takes place using a device certificate.

Furthermore, the confidentiality of the secret keys is of paramount importance in all cryptographic systems. A communication partner is then trustworthy only as long as the secret key also remains secret. For this purpose, it is possible for example to use specialized hardware that is intended to guarantee particularly secure storage of the keys. Access control to the keys is important in particular in the case of external additional components, such as external applications (apps), since not every application is able to be trusted to the same extent. For instance, for an application that is able to handle banking transactions, it is for example particularly important that no other application on the device has access to the secret key that is used.

For this purpose, it is possible for example to use a key attestation method In this case, properties of a generated key or key pair are confirmed through certification. A third party, such as for instance a network service, may then be reassured that a key is stored in a secure hardware module and that only one application has access to the key. In this case, the attestation of the generated key may be performed by a trusted component that generally originates from the manufacturer of the device. This trusted component certifies an exact description of the associated secret key, its access control, its storage in secure hardware, and possibly an “Attestation Challenge” of the network service in an attestation certificate. The certificates issued in this way are however not suitable for acceptance as proof of an identity for external services, since the certificate on the device does not correspond to a local certification authority.

It is furthermore possible for example, as in DE 102015201599 A1, to implement a system in which a computing apparatus monitors the behaviour of installed program modules, for example external communication and the use of user data. For this purpose, the computing apparatus itself is certified as trustworthy and as functioning correctly by virtue of a certificate for the computing apparatus being requested from a corresponding certification authority. This however requires for example comprehensive inspection mechanisms for the computing unit.

### SUMMARY OF THE INVENTION

The invention proposes a method for identifying an application to another communication participant and a method for authenticating a requesting application in a communication participant, and a computing unit and a computer program for performing same.

What is proposed in particular here is a method for identifying an application that is executed in an apparatus to another communication participant, which method comprises the following steps: obtaining a connection request for a secure connection between the application and the other communication participant; forming an information element that comprises at least one item of information about the application; signing the information element with a special first secret key, which is part of a cryptographic asymmetric key pair that is certified by an information certificate issued by an external, trusted authority; incorporating the signed information element into a connection request message; signing the connection request message with a secret device-specific key that is part of a cryptographic asymmetric key pair that is certified by a device-specific certificate (for example the device certificate) of the apparatus, and transmitting the connection request message to the other communication participant.

This makes it possible to implement a simple system for the secure use of device-specific keys in the authentication of communication participants. In contrast to normal methods, in the handshake of the connection setup, it is thus possible to forward not only static information about the external identity of a device, but also internal information about the access control measures taken for the apparatus. A trusted module on the apparatus thus thereby confirms the identity of the accessing application to another communication participant, for example a network service.

It is thereby possible to check the application that accesses the key. At the same time, however, the apparatus is capable of communicating by way of a device-specific certificate installed during manufacture, without a new certificate having to be issued for the apparatus. The amount of secret information on the apparatus is thus ultimately also kept as small as possible, so as to fit into hardware-based systems.

The device-specific certificate or the device certificate is preferably signed by an authority that is able to confirm the origin of the device, for example the manufacturer, whereas the information certificate is signed by an authority that is able to confirm the correct operation of the computer program.

The information element may in this case furthermore comprise information about the apparatus in which the application is executed, such as for example information as to whether a predefined group of system files is unchanged and undamaged (Verified Boot). The apparatus on which the application is installed may thus also be identified and assigned in a network service.

The secret key of the information certificate and/or that of the device certificate may preferably be stored in a secure hardware component of the apparatus, such that external access or access by unauthorized applications is able to be prevented.

The initial connection request may in this case be received from the application or from the other communication participant.

The abovementioned method steps may be performed in particular by a trusted module in the apparatus, wherein the information certificate and the associated keys are used only by the trusted module. In this case, the cryptographic keys that are certified by a device-specific certificate of the apparatus should preferably be able to be used only with the inclusion of the trusted module.

In some exemplary embodiments, it is also possible to store data in relation to the connection request, wherein the stored data comprise at least one of the following: information about the application, information about the other communication participant, information about the apparatus, a timestamp of the connection request, information about applied cryptographic operations. Key access operations to the device-specific key and use thereof may thereby not only be secured, but also be documented.

A method for authenticating an application may accordingly be implemented in another communication participant, for example a network service, using which method a secure connection is intended to be set up, comprising: receiving a connection request message; checking a device-specific signature with which the connection request message is signed; checking an information-related signature with which an information element embedded in the connection request message is signed; and, if the check on the signatures was successful, evaluating information in relation to the application that is contained in the embedded information element; and establishing a communication connection with the application on the basis of the evaluation. The network service may thus be given the ability to reliably identify the requesting application and its trustworthiness, without in the process having to take into account other security mechanisms for the application itself. In this case, evaluating information of the embedded information element may comprise a comparison with stored reference information. If the check on a signature was not successful, or the comparison yielded an invalid result, the connection setup may then be terminated.

A computing unit according to the invention, for example a processor or a virtual machine of an apparatus, is designed, in particular in terms of programming, to perform a method according to the invention.

The implementation of a method according to the invention in the form of a computer program or computer program product containing program code for performing all of the method steps is also advantageous, since this entails particularly low costs, in particular when an executing control device is also used for other tasks and is therefore present in any case. Suitable data carriers for providing the computer program are in particular magnetic, optical and electrical memories, such as for example hard disks, flash memories, EEPROMs, DVDs and the like. It is also possible to download a program via computer networks (the Internet, an intranet, etc.).

Further advantages and refinements of the invention will become apparent from the description and the accompanying drawing.

### BRIEF DESCRIPTION OF THE DRAWINGS

The invention is illustrated schematically in the drawing on the basis of exemplary embodiments and is described below with reference to the drawing.

FIG. 1 shows an exemplary system in which embodiments of the invention may be used;

FIG. 2 shows an exemplary method sequence in an apparatus according to one embodiment of the invention; and

FIG. 3 shows an exemplary method sequence in a communication participant that sets up a connection with the apparatus from FIG. 2.

### DETAILED DESCRIPTION

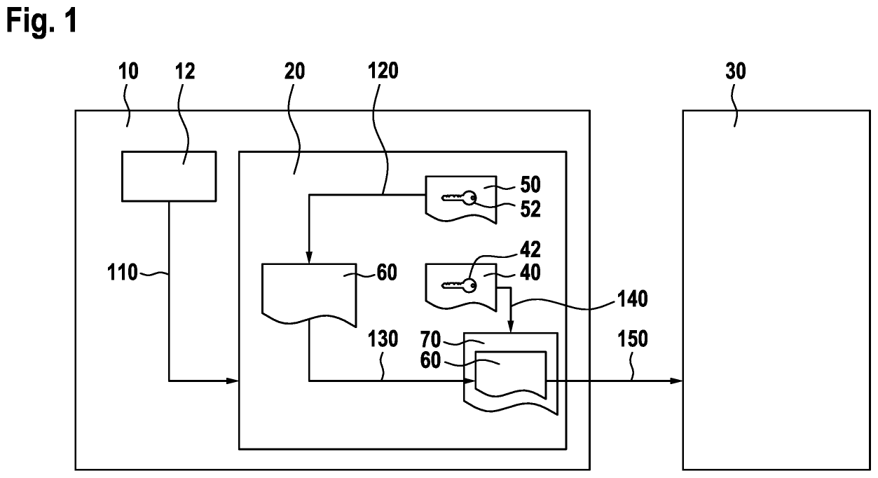

FIG. 1 schematically shows elements of an exemplary system in which embodiments of the invention may be applied.

In this case, an apparatus 10 contains, inter alia, a computing unit (not shown) for executing program modules that are stored in volatile or non-volatile memory elements. The computing unit may for example comprise one or more suitable processors. A wide variety of interfaces, such as for instance user interfaces for displaying and inputting data, communication interfaces for local or remote connections and the like, may also be present. The apparatus may be for example a user terminal such as a computer, mobile telephone, smartphone, tablet, or else any other device that has a communication interface and therefore requires an option for secure communication, for example with services in a local-area or wide-area network, such as for instance smart home devices or devices in the “Internet of Things” (IoT), networked vehicles and many more. An application in the industrial context is also conceivable, where production machines, manufacturing apparatuses, robots, partly autonomous systems and other units are increasingly being locally or globally networked and are able to be expanded subsequently by additional applications from the manufacturer or provided by the end consumer itself. Use in the context of an open platform is particularly advantageous, in which the additional applications are provided neither directly by the manufacturer nor by the end consumer, and are thus not able to be adapted to a specific device.

The apparatus 10 may, as is conventional, contain various applications or program modules 12 for executing certain functions, wherein the applications 12 may be installed by the manufacturer of the apparatus and/or be installed subsequently on the apparatus 10, for example through subsequent installation by a user.

The apparatus may contain a device-specific certificate 40 that was preferably installed by the manufacturer or during the manufacture or initial installation of the apparatus. The device-specific certificate 40 may, in the sense of a public key certificate, be linked to a public key of an asymmetric cryptographic key pair 42, wherein the secret key of the key pair may be stored in a special hardware component that is able to offer particular security. By way of example, access to this hardware component may be restricted to predefined trusted software.

The apparatus may furthermore comprise a trusted module 20. The trusted module 20 may for example be an operating system of the apparatus 10, or a limited system running in parallel with the operating system, but also a trusted program module introduced within an operating system. The trusted module may in this case be completely software-based or may be implemented in connection with certain hardware of the apparatus, for example a special secure environment.

This trusted module 20 may control access to the device-specific certificate 40 and all associated cryptographic operations. This means that in particular the signature of data that takes place using the secret key of the key pair linked to the device-specific certificate 40 is controlled. A connection or communication with a communication participant or service, for example a network service that is intended to use the device-specific certificate 40 and/or its associated keys 42, may thus be restricted such that this is possible only with the inclusion of the trusted module 20. Likewise, any application of the associated keys 42 (for example the signature of data for other units) may be possible only using the trusted module 20.

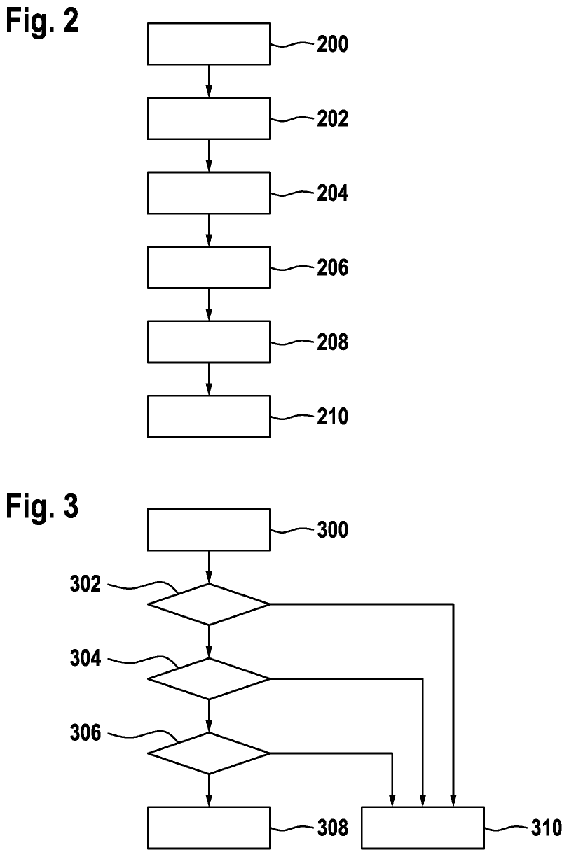

Possible method steps are now additionally described with reference to the sequence illustrated in FIG. 2.

In this case, in step 110 or 200, an application of the apparatus may make an initial connection request for a connection to a communication participant. Insofar as the application wishes to use the device-specific certificate or the associated keys, the connection request may therefore be directed to the trusted module and in the process jointly specify for example connection data for the communication participant, such as for instance a network address. The connection request may furthermore forward data to the trusted module that are intended to be sent in a connection request and/or a subsequent connection to the communication participant.

The trusted module 20 is also capable of collecting various information from an application of the apparatus that wishes to set up a connection that includes the trusted module. This may be for example a serial number of the application or another identifier, which may also be a unique identifier, licensing data, or other information. The trusted module 20 may also additionally in this step collect device-specific features and information about the status of the apparatus on which the module and the application are installed, such as for instance information as to whether firmware and/or system files have not been modified, a serial number or type number of the device used, information about apparatuses and interfaces that are present, information about secure hardware components and the like. This information, in particular the information of an apparatus, may in this case also be stored at least in part by or in the trusted module 20 and used in multiple connection requests. As an alternative, the information may be collected anew at least in part upon each connection setup via the trusted module. It is thereby possible for example to guarantee that the application has not been modified since a last connection setup. The collected information may then be processed in step 202 to form an information element that contains this information or at least part thereof.

The trusted module 20 may also have an information certificate 50 with associated keys. This information certificate 50 is preferably a different certificate from the device-specific certificate 40. The information certificate 50 may in particular be issued by a third party, for example a suitable trusted authority or certification authority, that is able to confirm the integrity of the trusted module 20. The information certificate may optionally also be issued for example by the manufacturer of the apparatus. This information certificate 50 may be intended inter alia to validate or to confirm and protect information that is provided by the trusted module. The formed information element may then be signed with the special secret key 52, which is certified by the information certificate 50, in step 120.

The trusted module 20 may then embed the collected information 60 about the application and/or the apparatus, signed with the key 52 of the information certificate 50, into a connection request message 70 in step 130 or 206, and sign this connection request message using the device-specific certificate (or with the associated secret key 42) in step 140 or 208. The trusted module 20 may then send the connection request message 70 with the embedded and signed information 60 to the communication participant 30 with which the application 12 wishes to set up a connection, in step 210, for example as part of a handshake. The signed information 60 may in principle alternatively also be transmitted to the communication participant 30 at another, later time.

The second communication participant may thus firstly obtain information about the application and check whether this meets particular requirements, and may at the same time guarantee that this obtained information about the application originates from the trusted module and may thus be classified as reliable.

FIG. 3 shows an exemplary method sequence in another communication participant 30, for example in a network service, which sets up a connection with the apparatus 10 in order to communicate with the application 12 in a handshake.

The other communication participant 30 may in this case first of all receive the connection request message obtained from the trusted module 20 in step 300. The connection request may for example be identified as such via a suitable header, wherein elements may also serve to indicate the secure authentication method. The communication participant may then, in step 302, check the signature of the connection request message and, in step 304, check the signature of the information element embedded therein.

For this purpose, the corresponding certificates, for example the certificate of the trusted module, various manufacturer certificates or certificates from certification authorities may be present in stored form for the communication participant 30 for comparison purposes. As an alternative, the communication participant may also have an option of obtaining the required certificates from another authority, and/or at least the certificate of the trusted module may be received together with the connection request module from the module itself. As a result, it is possible for the communication participant to check both the trustworthiness of the certificate and the signature on the basis of the public key contained in the respective certificate.

If the signatures have been checked successfully, the data, contained in the information element, in relation to the apparatus and/or the application may then be extracted and evaluated in step 306. To this end, said data may for example be compared with stored information. It is optionally also possible for no further separate validation of these data to take place in this step, but rather for these data to be used only for the connection and/or stored locally, while the authentication of the application is based on the successfully checked signatures.

If the communication participant 30, that is to say for example the network service, arrives at the conclusion in this case that either at least one of the certificates 40, 50 used is not trustworthy and thus a suitable trusted component is not controlling the connection setup, or that information about the application and/or the apparatus from the information element does not correspond to its own requirements for setting up the connection or for providing the desired service, the connection setup may be terminated in step 310, wherein corresponding feedback may optionally be transmitted to the apparatus.

Otherwise, the requested connection between the other communication participant 30 and the application 12 may then be successfully set up in step 308 and used for example to provide services and to exchange data, wherein the device-specific key pair may optionally be used as part of mutual cryptographic securing of the further connection.

Likewise, the described method steps may be used both on the side of the apparatus 10 and on the side of the other communication participant 30 when an external service wishes to set up a connection to a local application 12 on the apparatus, that is to say when the connection request originates from the other communication participant 30. The trusted module may then also collect the various information about the application and the apparatus and form therefrom an information element that is accordingly embedded into a signed connection request message and that may be evaluated by the requesting communication participant.

The trusted module and/or the other communication participant may in this case store any information in relation to the connection request and the participants for subsequent processing and use. By way of example, information about the application, information about the other communication participant, information about the apparatus, a timestamp of the connection request and/or information about applied cryptographic information and about the success or failure of the connection request may be stored.

It goes without saying that all of the described variants have been illustrated only as examples and these could be supplemented inter alia by further method steps or individual method steps could also be omitted. The various exemplary embodiments and in particular their individual components and method steps may likewise also be combined with one another.

1. A method for identifying an application (12) that is executed in a first computer (10) to a second computer, the method comprising:
obtaining (200), via the first computer, a connection request (110) for a secure connection between the application (12) and the second computer).
forming (202), via the first computer, an information element that comprises at least one item of information about the application (12);
signing (204), via the first computer, the information element with a first secret key (52), which is part of a cryptographic asymmetric key pair that is certified by an information certificate (50) issued by an external trusted authority;
incorporating (206), via the first computer, the signed information element (60) into a connection request message (70);
signing (208), via the first computer, the connection request message (70) with a secret device-specific key (42) that is part of a cryptographic asymmetric key pair that is certified by a device-specific certificate (40) of the first computer; and
transmitting (210), via the first computer, the connection request message (70) to the second computer.

2. The method according to claim 1, wherein the information element (60) furthermore comprises information about the first computer (10) in which the application is executed.

3. The method according to claim 1, wherein the secret device-specific key (42) is stored in a secure hardware component of the first computer.

4. The method according to claim 1, wherein the connection request (110) is obtained from the application (12) or from the second computer.

5. The method according to claim 1, wherein the method steps are performed by a trusted module (20) in the first computer, wherein the information certificate (50) and the associated keys are used only by the trusted module.

6. The method according to claim 5, wherein the cryptographic keys (42) that are certified by a device-specific certificate of the first computer are able to be used only with the inclusion of the trusted module (20).

7. The method according to claim 1, wherein the information certificate (50) and the device-specific certificate (40) are identical.

8. The method according to claim 1, furthermore comprising:
storing data in relation to the connection request, wherein the stored data comprise at least one of the following: information about the application, information about the other communication participant, information about the first computer, a timestamp of the connection request, information about applied cryptographic operations.

9. The method for authenticating an application with which a secure connection is intended to be set up, the method comprising:
receiving (300), via a second computer, a connection request message (70) from a first computer;
checking (302), via the second computer, a device-specific signature with which the connection request message is signed;
checking (304), via the second computer, an information-related signature with which an information element embedded in the connection request message is signed;
and, if the check on the signatures was successful, evaluating (306), via the second computer, information in relation to the application that is contained in the embedded information element, and establishing (308) a communication connection with the application on the basis of the evaluation.

10. The method according to claim 9, wherein evaluating information of the embedded information element comprises a comparison with stored reference information.

11. The method according to claim 9, further comprising terminating the connection setup if the check on a signature was not successful.

12. (canceled)

13. (canceled)

14. A non-transitory, computer-readable storage medium containing instructions that when executed by a first computer cause the first computer to identify an application (12) that is executed in the first computer (10) to a second computer, by:
obtaining (200) a connection request (110) for a secure connection between the application (12) and the second computer (30);
forming (202) an information element that comprises at least one item of information about the application (12);
signing (204) the information element with a first secret key (52), which is part of a cryptographic asymmetric key pair that is certified by an information certificate (50) issued by an external trusted authority;
incorporating (206) the signed information element (60) into a connection request message (70);
signing (208) the connection request message (70) with a secret device-specific key (42) that is part of a cryptographic asymmetric key pair that is certified by a device-specific certificate (40) of the first computer; and
transmitting (210), the connection request message (70) to the second computer.
